(19) United States
(12) Patent Application Publication
(10) Pub. No.: US 2008/0211382 A1
(43) Pub. Date: Sep. 4, 2008

(54) Image display device

(76) Inventors: Tsutomu Kuniyasu, Mobara (JP); Takahiro Ueno, Mobara (JP); Go Saitou, Mobara (JP); Hiroshi Kawasaki, Ooamishirasato (JP)

Correspondence Address: MILBANK, TWEED, HADLEY & MCCLOY, 1 CHASE MANHATTAN PLAZA, NEW YORK, NY, 10005-1413, US

(21) Appl. No.: 11/986,945

(22) Filed: Nov. 27, 2007

(30) Foreign Application Priority Data
Dec. 4, 2006 (JP) 2006-327270

(51) Int. Cl. H01J 1/62

(52) U.S. Cl. 313/495

(57) ABSTRACT

The present invention achieves a desired white color temperature without deteriorating white uniformity and without lowering brightness in a field emission display (FED). A width of a green phosphor is set larger than a width of a red phosphor or a width of a blue phosphor and, at the same time, a distance between the center of the red phosphor and the center of the green phosphor is set larger than a distance between the center of the blue phosphor and the center of the red phosphor. Due to such a constitution, black matrix widths between the respective phosphors are set to a fixed value. Simultaneously, positions of electron sources are set in conformity with the positions of the respective phosphors. Due to such a constitution, it is possible to realize a desired white color temperature without deteriorating landing tolerance of electron beams or without lowering a utilization efficiency of a phosphor screen.

### CLAIM OF PRIORITY

The present application claims priority from Japanese Application JP 2006-327270 filed on Dec. 4, 2006, the content of which is hereby incorporated by reference into this application.

### BACKGROUND OF THE INVENTION

1. Field of the Invention

The present invention relates to a flat display device which evacuates the inside thereof into a vacuum, arranges electron sources on a back substrate in a matrix array and arranges phosphors corresponding to the electron sources on a face substrate, and more particularly, to color temperature and uniformity of white when white is displayed.

2. Description of Related Arts

As a display device which exhibits excellent properties such as high brightness and high definition, a color cathode ray tube has been popularly used conventionally. However, from viewpoints of space saving, reduction of weight and the like, a demand for a flat image display device has been expanding. Even when a liquid crystal display device, a plasma display device or the like adopts a large screen of 30 inches or more, a weight of such a display device is not increased largely. Accordingly, a demand for the flat display device has been also expanding in a field of large-sized display devices such as television receiver sets.

On the other hand, the development of a so-called field emission display (hereinafter referred to as FED) is in progress. Here, the FED is a display device which creates a vacuum in the inside thereof sandwiched by two glass substrates, arranges electron sources on one substrate in a matrix array, and arranges phosphors on a counter substrate. The FED forms an image based on a phenomenon that electrons from electron sources impinge on phosphors so that the phosphors emit light. The FED can acquire excellent performances compatible to a CRT display device with respect to brightness, contrast, motion image characteristics and the like and hence, the FED is expected as a future display for a television receiver set.

As one of drawbacks which the FED possesses, there exists a drawback on color temperature when white is displayed. The phosphor screen structure of the FED is configured such that phosphors of red, green and blue are formed in a matrix array, and a black matrix (BM) is filled between the red, green and blue phosphors. In other words, the black matrix is formed on the whole surface of the phosphor screen, and the phosphors of red, green and blue are filled in holes formed in the black matrix. In such a related art, sizes of respective phosphors of red, green and blue are equal.

However, it is difficult for such phosphor screen structure to generate color temperature of 9300K in NTSC standard white. That is, the phosphors of red, green and blue differ from each other in light emitting efficiency. Although an attempt has been made to generate the color temperature of 9300K, the emission of green light becomes relatively insufficient. Accordingly, when the phosphors of red, green and blue are formed with the same size, the phosphor screen exhibits magenta-based white as a whole. Here, the color temperature becomes 4500K, for example.

As a related art which is provided to cope with such a drawback, a technique disclosed in patent document 1 (JP-A-2006-73386) is named. That is, patent document 1 describes the technique in which areas of the phosphors of red and blue are set smaller than an area of the phosphor of green for acquiring a predetermined color balance. To be more specific, patent document 1 describes an idea of setting long diameters of the phosphors of red and blue smaller than a long diameter of the phosphor of green or an idea of setting areas of the phosphors of red and blue relatively smaller than an area of the phosphor of green by forming light blocking portions by dividing the phosphors of red and blue.

### SUMMARY OF THE INVENTION

However, in the technique described in patent document 1, it is necessary to decrease the areas of the phosphors of red and blue and hence, a utilization efficiency of the phosphor screen is lowered. As a result, there arises a drawback that the brightness of the FED is lowered. Accordingly, it is an object of the present invention to provide an image display device which can acquire a desired color temperature without lowering a utilization efficiency of a phosphor screen.

The present invention has been made to overcome the above-mentioned drawbacks of the related art and is characterized by changing pitches of red, green and blue phosphors on a phosphor screen and by increasing a width of the green phosphor simultaneously. Due to such a constitution, even when a light emitting area of the green phosphor is set larger than a light emitting area of other phosphors, it is possible to prevent the absence of electron beam in the phosphor or the hitting of electron beams on the phosphor of other color.

Here, to accurately acquire a desired color balance, in addition to setting of the width of the phosphor of green larger than the width of other phosphor, it may be necessary to change the respective areas of the phosphors of red, green and blue and respective distances between the respective phosphors.

Corresponding to the change of the areas of the phosphors for respective colors or the changes of distances between the respective phosphors, it may be necessary to change positions and areas of electron sources. Specific constitutions of the image display device of the present invention are as follows.

(1) The present invention is directed to a display device including a cathode substrate on which electron sources are mounted in a matrix array, and an anode substrate which faces the cathode substrate in an opposed manner, allows an anode voltage to be applied thereto, and forms phosphors at portions thereof corresponding to the electron sources, the display device holding a vacuum in the inside thereof, wherein a black matrix is formed on the anode substrate, red phosphors, green phosphors and blue phosphors are arranged in parallel in opening portions formed in the black matrix, a width of the green phosphor is set larger than a width of the red phosphor or a width of the blue phosphor, a distance between the center of the red phosphor and the center of the green phosphor is set larger than a distance between the center of the red phosphor and the center of the blue phosphor, and a black matrix width between the red phosphor and the green phosphor, a black matrix width between the green phosphor and the blue phosphor, and a black matrix width between the blue phosphor and the red phosphor are set approximately equal to each other.

(2) A display device described in the above item (1) is characterized in that a range of equality among the black matrix width between the red phosphor and the green phosphor, the black matrix width between the green phosphor and the blue phosphor, and the black matrix width between the blue phosphor and the red phosphor is within 4%.

(3) A display device described in the above item (1) is characterized in that the width of the red phosphor is equal to the width of the blue phosphor.

(4) A display device described in the above item (1) is characterized in that the distance between the center of the green phosphor and the center of the blue phosphor is larger than the distance between the center of the blue phosphor and the center of the red phosphor.

(5) A display device described in the above item (1) is characterized in that the width of the green phosphor is set larger than the width of either one of the red phosphor and the blue phosphor by 5% or more.

(6) A display device described in the above item (1) is characterized in that the width of the green phosphor is set larger than the width of either one of the red phosphor and the blue phosphor by 10% or more.

(7) A display device described in the above item (1) is characterized in that the width of the green phosphor is set larger than the width of either one of the red phosphor and the blue phosphor by 15% or more.

(8) The present invention is directed to a display device including a cathode substrate on which electron sources are mounted in a matrix array, and an anode substrate which faces the cathode substrate in an opposed manner, allows an anode voltage to be applied thereto, and forms phosphors at portions thereof corresponding to the electron sources, the display device holding a vacuum in the inside thereof, wherein

a black matrix is formed on the anode substrate, red phosphors, green phosphors and blue phosphors are arranged in parallel in opening portions formed in the black matrix, a width of the green phosphor is set larger than a width of the red phosphor or a width of the blue phosphor, a distance between the center of the red phosphor and the center of the green phosphor is set larger than a distance between the center of the red phosphor and the center of the blue phosphor, and

red electron sources which allow electrons to impinge on the red phosphors, green electron sources which allow electrons to impinge on the green phosphors, and blue electron sources which allow electrons to impinge on the blue phosphors are formed on the cathode substrate, and a distance between the center of the red electron source and the center of the green electron source is set larger than a distance between the center of the red electron source and the center of the blue electron source.

(9) A display device described in the above item (8) is characterized in that a distance between the center of the green electron source and the center of the blue electron source is set larger than a distance between the center of the blue electron source and the center of the red electron source.

(10) A display device described in the above item (8) is characterized in that the difference between a distance between the center of the red electron source and the center of the green electron source and a distance between the center of the blue electron source and the center of the red electron source is made in the direction which makes the center of the red electron source and the center of the red phosphor agree to each other and in the direction which makes the center of the green electron source and the center of the green phosphor agree to each other.

(11) A display device described in the above item (9) is characterized in that a distance between the center of the green electron source and the center of the blue electron source is set larger than a distance between the center of the blue electron source and the center of the red electron source, and the difference between a distance between the center of the green electron source and the center of the blue electron source and a distance between the center of the blue electron source and the center of the red electron source is made in the direction which makes the center of the green electron source and the center of the green phosphor agree to each other and in the direction which makes the center of the blue electron source and the center of the blue phosphor agree to each other.

(12) A display device described in the above item (8) is characterized in that a signal line which supplies a signal to the green electron source has a width larger than a width of a signal line which supplies a signal to another electron source.

(13) A display device described in the above item (8) is characterized in that a signal line which supplies a signal to the red electron source, a signal line which supplies a signal to the green electron source, and a signal line which supplies a signal to the blue electron source are arranged at a same pitch.

(14) A display device described in the above item (8) is characterized in that a width of a signal line which supplies a signal to the red electron source, a width of a signal line which supplies a signal to the green electron source and a width of a signal line which supplies a signal to the blue electron source are set equal to each other.

(15) A display device described in the above item (8) is characterized in that the red electron source is formed on a red signal line which supplies a signal to the red electron source, the green electron source is formed on a green signal line which supplies a signal to the green electron source, and the blue electron source is formed on a blue signal line which supplies a signal to the blue electron source, and the center of the red electron source is offset from the center of the red signal line or the center of the blue electron source is offset from the center of the blue signal line.

(16) A display device described in the above item (8) is characterized in that the red electron source is formed on the red signal line which supplies a signal to the red electron source, the green electron source is formed on the green signal line which supplies a signal to the green electron source, and the blue electron source is formed on the blue signal line which supplies a signal to the blue electron source, and a width of the red signal line in the vicinity of the red electron source is set larger than the width of the red signal line in other portions or the width of the blue signal line in the vicinity of the blue electron source is set larger than the width of the blue signal line in other portions.

(17) The present invention is directed to a display device including a cathode substrate on which electron sources are mounted in a matrix array, and an anode substrate which faces the cathode substrate in an opposed manner, allows an anode voltage to be applied thereto, and forms phosphors at portions thereof corresponding to the electron sources, the display device holding a vacuum in the inside thereof, wherein a black matrix is formed on the anode substrate, red phosphors, green phosphors and blue phosphors are arranged in parallel in opening portions formed in the black matrix, a width of the green phosphor is set larger than a width of the blue phosphor, and a width of the blue phosphor is set larger than a width of the red phosphor, a distance between the center of the red phosphor and the center of the green phosphor is set larger than a distance between the center of the red phosphor and the center of the blue phosphor, and a black matrix width between the red phosphor and the green phosphor, a black matrix width between the green phosphor and the blue phosphor, and a black matrix width between the blue phosphor and the red phosphor are set approximately equal to each other.

(18) A display device described in the above item (17) is characterized in that a range of equality among the black matrix width between the red phosphor and the green phosphor, the black matrix width between the green phosphor and the blue phosphor, and the black matrix width between the blue phosphor and the red phosphor is within 4%.

(19) A display device described in the above item (17) is characterized in that the width of the red phosphor is 0.9 times or less as large as the width of the green phosphor.

(20) A display device described in the above item (17) is characterized in that the width of the red phosphor is 0.85 times or less as large as the width of the green phosphor.

According to the present invention, it is possible to obtain a desired color temperature without lowering the brightness of a phosphor screen and without lowering color purity. To explain advantageous effects acquired by the present invention for respective constitutions, they are as follows.

According to the above items (1) to (7), the white color temperature can be made close to 9300K by increasing the width of the green phosphor and, at the same time, by changing the distance between the centers of the respective phosphors, the width of the black matrix between the respective phosphors can be set to a fixed value and hence, it is possible to prevent lowering of the brightness of the phosphor screen as well as the deterioration of color purity.

According to the above items (8) to (16), the white color temperature can be made close to 9300K by increasing the width of the green phosphor and, at the same time, by changing the distance between the centers of the respective phosphors, it is possible to prevent the deterioration of the color purity and lowering of brightness of the phosphor screen. Further, the distance between the centers of the electron sources corresponding to the respective phosphors can be also changed in conformity with the distance between the centers of the phosphors and hence, it is possible to ensure the prevention of deterioration of color purity.

According to the above items (17) to (20), by allowing the widths of the respective phosphors to satisfy the relationship of width of green phosphor>width of blue phosphor>width of red phosphor, the white color temperature can be made close to 9300K more easily. Further, by changing the distance between the centers of the respective phosphors, the widths of the black matrix between the respective phosphors can be set to a fixed value and hence, it is possible to prevent lowering of the brightness of the phosphor screen as well as the deterioration of color purity.

### BRIEF DESCRIPTION OF THE DRAWINGS

FIG. 1 is a plan view showing a display device according to an embodiment 1 of the present invention;

FIG. 2 is a side view of the display device shown in FIG. 1;

FIG. 3 is a cross-sectional view taken along a line A-A in FIG. 1;

FIG. 4 is a cross-sectional view taken along a line B-B in FIG. 1;

FIG. 5 is a cross-sectional view taken along a line C-C in FIG. 1;

FIG. 6 is a schematic view of a phosphor screen of the display device according to the embodiment 1;

FIG. 7 is a schematic view of the phosphor screen of the display device according to the embodiment 1 in a state that an electron beam profile is added to the phosphor screen;

FIG. 8A and FIG. 8B are schematic views of the phosphor screen showing drawbacks when the present invention is not used;

FIG. 9 is a plan view showing the vicinity of electron sources of the display device according to the embodiment 1;

FIG. 10 is a cross-sectional view of an MIM-type electron source;

FIG. 11A is a plan view of a phosphor screen of a display device according to an embodiment 2, and FIG. 11B is a plan view of the vicinity of a signal line terminal portion of the display device according to the embodiment 2;

FIG. 12 is a plan view showing the vicinity of electron sources of a display device according to an embodiment 3;

FIG. 13 is a plan view showing the vicinity of electron sources of a display device according to an embodiment 4;

FIG. 14 is a plan view showing the vicinity of electron sources of a display device according to an embodiment 5; and

FIG. 15 is a schematic view of a phosphor screen of a display device according to an embodiment 6.

### DESCRIPTION OF THE PREFERRED EMBODIMENTS

Hereinafter, best modes for carrying out the present invention are explained in detail in conjunction with drawings of embodiments.

### Embodiment 1

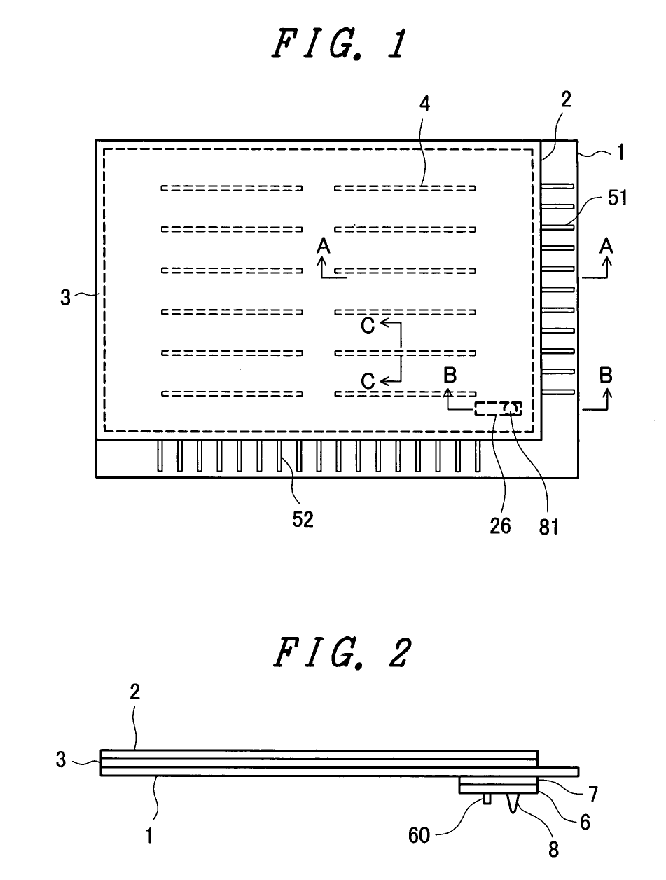

FIG. 1 to FIG. 10 are views showing a display device of an embodiment 1 of the present invention. In FIG. 1 to FIG. 5, an anode substrate 2 is mounted on a cathode substrate 1 by way of a sealing portion 3. On the cathode substrate 1, scanning lines 11 extend in the lateral direction and data signal lines 12 extend in the longitudinal direction. Signals are supplied to the scanning lines 11 from scanning line terminals 51, and signals are supplied to data signal lines 12 from the outside by way of data signal line terminals 52. Electron sources are arranged in the vicinity of intersecting portions of the scanning lines 11 and the data signal lines 12. Accordingly, a large number of electron sources are arranged in a matrix array. Although various kinds of electron sources such as so-called MIM-method electron sources, SED-method electron sources or Spindt-method electron sources have been developed as such electron sources, the present invention is applicable to any electron sources. This embodiment uses the MIM-method electron sources as an example of the electron sources.

The inside of the display device defined by the cathode substrate 1, the anode substrate 2 and the sealing portion 3 which surround peripheries of the cathode substrate 1 and the anode substrate 2 is held in a vacuum. Accordingly, there exits a possibility that the anode substrate 2 or the cathode substrate 1 is deflected due to an atmospheric pressure so that a distance between the cathode substrate 1 and the anode substrate 2 cannot be ensured. Alternatively, the cathode substrate 1 or the anode substrate 2 may be broken. To avoid such a drawback, spacers 4 are arranged between the cathode substrate 1 and the anode substrate 2. The spacers 4 are made of ceramics or glass, and are generally arranged on the scanning lines so as to prevent the interruption of formation of images.

On the anode substrate 2, phosphors of red, green and blue which emit light due to an impingement of electron beams thereto are formed corresponding to the electron sources. A black matrix (BM) is formed around the phosphors for enhancing a contrast of images. A metal back 25 made of Al is formed to cover the black matrix. A high voltage is applied to the metal back 25 to accelerate electron beams 15 radiated from a cathode and to make electron beams 15 impinge on the red phosphors 21, the green phosphors 22 and the blue phosphors 23.

To make the phosphors emit light by making the electron beams 15 impinge on the phosphors, the electron beams 15 are required to possess a certain level of energy and hence, a high voltage of 8 KV to 10 KV is applied to the metal back 25 of the anode substrate 2. In this embodiment, a high voltage lead terminal is mounted on a cathode-substrate side, and a high voltage is applied to the anode substrate 2 via a contact spring. In FIG. 1, the contact spring and an anode terminal with which the anode substrate 2 comes into contact are formed in a corner portion of the display device. Since the inside of the display device is required to be held in a vacuum, an exhaust hole 81 for discharging air is formed in the corner portion of the display device shown in FIG. 1.

FIG. 2 is a side view of the display device shown in FIG. 1 as viewed from below a surface of the drawing. In FIG. 2, the cathode substrate 1 and the anode substrate 2 are arranged to face each other in an opposed manner with a predetermined distance therebetween by way of the sealing portion 3. The cathode substrate 1 is formed larger than the anode substrate 2 by an amount corresponding to mounting of terminals 51 and the like on the cathode substrate 1. On a lower surface of the cathode substrate 1, an exhaust substrate 6 for mounting an exhaust pipe 8 and a high voltage leading button 60 is mounted. The exhaust substrate 6 is mounted on the cathode substrate 1 by way of an exhaust substrate sealing portion 7. In FIG. 2, the exhaust pipe 8 which is mounted on the exhaust substrate 6 for creating a vacuum in the inside of the display device is depicted in a tip-off state. The high voltage leading button 60 is mounted in the vicinity of the exhaust pipe 8.

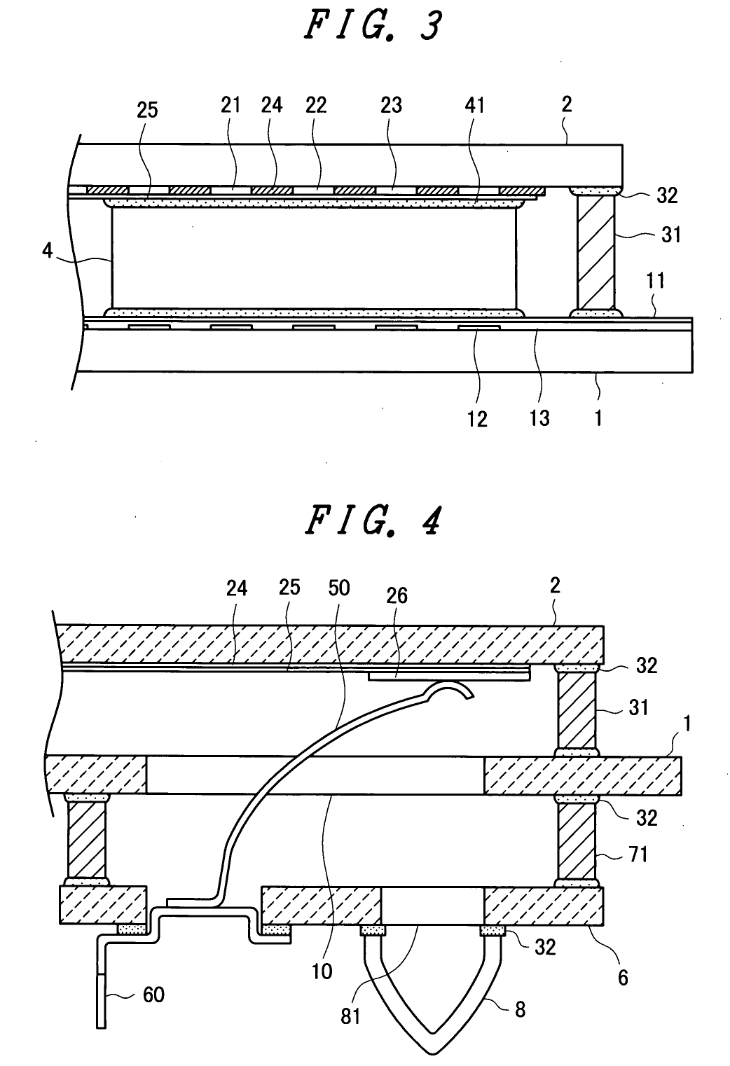

FIG. 3 is a cross-sectional view taken along a line A-A in FIG. 1. In FIG. 3, the data signal lines 12 extend in the direction perpendicular to a surface of the drawing. In this embodiment, electron sources 14 are formed on the data signal lines 12. The scanning lines 11 are formed in the direction orthogonal to the data signal lines 12 by way of an insulation film 13. In FIG. 3, the scanning lines 11 extend to the outside of the sealing portion 3. The spacers 4 are mounted on the scanning lines 11 for ensuring a distance between the cathode substrate 1 and the anode substrate 2. The spacers 4 are fixed to the scanning lines 11 on a cathode-substrate side by a fixing material 41 and are fixed to a metal back 25 on an anode-substrate side. Conductivity of approximately 10⁸ to 10⁹Ω is imparted to the spacers 4, and a slight amount of electric current flows between the cathode and the anode to prevent charging of the spacers 4.

On the anode-substrate side, red phosphors 21, green phosphors 22 and blue phosphors 23 are arranged at positions corresponding to the electron sources 14. These red phosphors 21, green phosphors 22 and blue phosphors 23 emit light upon impingement of the electron beams 15 on these phosphors 21, 22, 23 thus forming an image. A black matrix 24 is formed by being filled between the red phosphors 21, the green phosphors 22 and the blue phosphors 23 thus contributing to the enhancement of contrast of an image. The black matrix 24 has the two-layered structure consisting of a chromium layer and a chromium oxide layer, for example. The metal back 25 made of Al is formed in a state that the metal back 25 covers the red phosphors 21, the green phosphors 22, the blue phosphors 23 and the black matrix 24. A high-voltage of approximately 8 KV to 10 KV is applied to the metal back 25 to accelerate the electron beams 15. The accelerated electron beams 15 penetrate the metal back 25 and impinge on the red phosphors 21, the green phosphors 22 and the blue phosphors 23 and make the red phosphors 21, the green phosphors 22 and the blue phosphors 23 emit light.

To maintain the inside of the display device in a vacuum state, the cathode substrate 1 and the anode substrate 2 are sealed by a frame member 31 and a sealing material 32. A thickness of the cathode substrate 1 and a thickness of the anode substrate 2 are set to approximately 3 mm. Further, the distance between the cathode substrate 1 and the anode substrate 2 is set to approximately 2.8 mm and a high electric field is formed in the inside of the display device.

FIG. 4 is a cross-sectional view taken along a line B-B in FIG. 1. In FIG. 4, a through hole 10 is formed in the cathode substrate 1, and an exhausting operation of the display device and the supply of a high voltage are performed through the through hole 10. The exhaust substrate 6 is mounted on the cathode substrate 1 by way of the exhaust substrate sealing portion 7 in a state that the exhaust substrate 6 covers the through hole 10 formed in the cathode substrate 1, and the exhaust substrate 6 maintains the inside of the display device in a vacuum state. The exhaust substrate sealing portion 7 shares the same basic constitution with the sealing portion 3 for sealing the cathode substrate 1 and the anode substrate 2. That is, an exhaust substrate frame body 71 is sealed to the cathode substrate 1 by way of the sealing material 32.

On the exhaust substrate 6 which is mounted on the cathode substrate 1, the high voltage leading button 60 is hermetically mounted using the sealing material 32 in a state that the air tightness of the space inside the display device from the outside is maintained. The sealing material 32 is made of frit glass. The high voltage leading button 60 is made of Fe—Ni alloy. A content ratio of Fe—Ni alloy is selected such that a thermal expansion coefficient of Fe—Ni alloy agrees to a thermal expansion coefficient of the sealing material 32. A contact spring 50 is fixed to the high voltage leading button 60 by spot welding. Although the contact spring 50 is made of Inconel, the contact spring 50 can be easily fixed to the high voltage leading button 60 made of Fe—Ni alloy by spot welding.

Due to a bending stress generated by curving the contact spring 50, the contact spring 50 is brought into contact with the metal back 25 formed on the anode substrate 2 with a proper force. In this embodiment, a contact pressure of the contact spring 50 is approximately 10 g. A contact portion of the contact spring 50 is configured to have a proper curved surface such as a spherical surface to acquire a stable contact with the metal back 25. Inconel is used as a material of the contact spring 50 in view of heat resistance and the like, and a thickness of the contact spring 50 is set to 0.1 mm.

An anode terminal 26 which comes into contact with the contact spring 50 is formed on the anode substrate 2. Since a relatively large electric current flow into the anode terminal 26, the anode terminal 26 is required to ensure the sufficient reliability. In this embodiment, the anode terminal 26 has the following structure. The black matrix 24 made of chromium and chromium oxide is formed on the anode substrate 2 and the metal back 25 made of Al is formed on the anode substrate 2 in a state that the metal back 25 covers the black matrix 24. This constitution is equal to the constitution of an effective surface of the screen. In this embodiment, a conductive film having a thickness of 10 μm to 30 μm is formed on the metal back 25 as the anode terminal 26. In this embodiment, a conductive film is formed by applying a silver paste to the metal back 25 by printing and, thereafter, by baking the applied silver paste. It is unnecessary to provide a particular process for baking the conductive film and, for example, baking of the conductive film may be simultaneously performed in a baking process for fixing the spacers 4.

The silver paste is formed by dispersing silver particles having a diameter of 1 μm to several μm in an organic solvent having high viscosity. The silver paste acquires conductivity due to bonding of the silver particles to each other after baking. There may be a case that the conductive film preferably has some resistance. In such a case, the resistance may be adjusted by further mixing a frit-glass paste in a usual silver paste. Here, a material of the conductive film is not limited to the silver paste. An Ni paste which is formed by dispersing Ni particles in an organic solvent, an Al paste which disperses Al particles in an organic solvent or the like can be also used. Further, it is also possible to use a graphite film which bonds graphite particles using a binder. In this case, graphite particles may be preferably used as graphite particles. The resistance of the graphite film can be adjusted by mixing iron oxide (including red iron oxide) into graphite, for example.

By forming the conductive film having a large thickness of 10 μm to 30 μm, it is possible to ensure a stable contact between the contact spring 50 and the conductive film. That is, when the conductive film is formed of a metal film, the contact spring 50 and the metal film are brought into contact with each other by a point contact, and an electric current flows in a point contact portion concentrically thus giving rise to a large possibility of breaking the conductive film. By adopting the conductive film of this embodiment, the contact between such a conductive film and the contact spring 50 can ensure a large contact area compared to the contact between the metal film and the contact spring 50 and hence, the contact becomes substantially equal to a face contact whereby the contact becomes stable. Further, by adopting the conductive film of this embodiment, the resistance of the conductive film can be increased compared to the metal film and hence, it is possible to prevent a large electric current from flowing into the contact portion. The stability of conductivity due to the contact can be enhanced also from this viewpoint.

An exhaust hole 81 is formed in the exhaust substrate 6, and the exhaust pipe 8 is mounted on an opening portion of the exhaust hole 81 by way of frit glass which forms the sealing material 32. The inside of the display device is evacuated into a vacuum through the exhaust pipe 8 and, thereafter, the exhaust pipe 8 is tipped off so as to maintain the inside of the display device in a vacuum state. FIG. 4 shows the exhaust pipe 8 in a tip-off state.

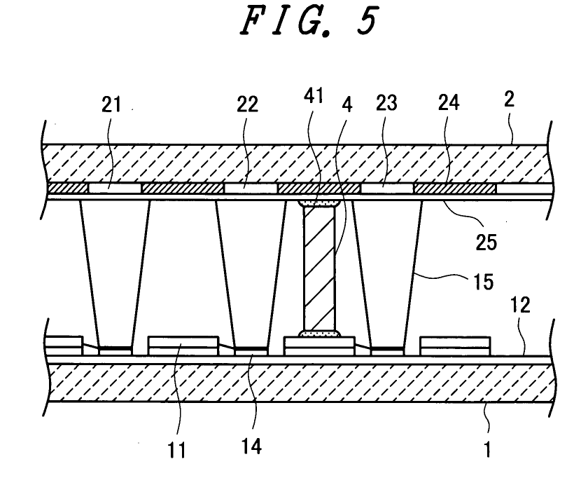

FIG. 5 is a schematic view showing a cross section taken along a line C-C in FIG. 1. In FIG. 5, the data signal lines 12 extend on the cathode substrate 1 in the lateral direction. The scanning lines 11 extend in the normal direction of a surface of the drawing orthogonal to the data signal lines 12. The scanning lines 11 adopt the two-layered structure for decreasing the wiring resistance. The electron sources 14 are arranged on the data signal line 12 arranged between the scanning lines. The electron source 14 is constituted of a lower electrode which forms the data signal line 12 and an upper electrode which is electrically connected with the scanning line 11 via a tunnel insulation film.

The red phosphors 21, the green phosphors 22 and the blue phosphors 23 are formed on the anode substrate 2, and a space defined between the phosphors is covered with the black matrix 24. By sputtering Al such that Al covers the phosphors and the black matrix 24, the metal back 25 is formed. An anode voltage of high voltage ranging from approximately 8 KV to 10 KV is applied to the metal back 25. The electron beams 15 emitted from the electron sources 14 by the anode voltage are accelerated. The electron beams 15 emitted from the electron sources 14 penetrate the metal back 25 and impinge on the red phosphors 21, the green phosphors 22 and the blue phosphors 23 thus forming a color image. Although the electron beams 15 spread when the electron beams 15 are emitted from the electron sources 14, on the phosphor screen, each electron beam 15 is designed to be slightly larger than each phosphor.

To maintain the distance between the anode substrate 2 and the cathode substrate 1, as explained in conjunction with FIG. 3, the spacers 4 are arranged. The spacers 4 are arranged between the scanning lines 11 on the cathode substrate 1 and the metal back 25 on the anode substrate 2. Due to such positioning of the spacers 4, the spacers 4 do not impede the formation of images.

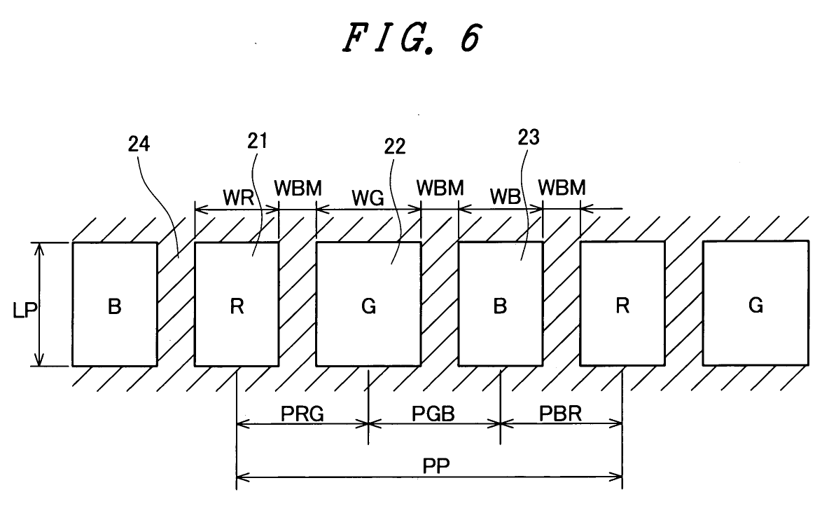

FIG. 6 is a partially enlarged view showing the constitution of the phosphor screen of the image display device according to this embodiment. FIG. 6 shows only some phosphors and other phosphors are omitted. In FIG. 6, the red phosphors 21, the green phosphors 22, the blue phosphors 23 and the black matrix 24 are formed on the anode substrate 2. Although the metal back 25 is formed on the anode substrate 2 in a state that the metal back 25 covers the phosphors and the black matrix 24, the metal back 25 is not shown in FIG. 6.

To set a white color temperature to 9300K, a width WG of the green phosphor 22 is set larger than a width WR of the red phosphor 21 or a width WB of the blue phosphor 23. In this embodiment, the width WR of the red phosphor 21 and the width WB of the blue phosphors 23 are set equal to each other. On the other hand, a distance PRG between the green phosphor 22 and the red phosphor 21 and a distance PGB between the green phosphor 22 and the blue phosphor 23 are set equal to each other and, at the same time, the distance PRG and the distance PGB are set larger than a distance PBR between the blue phosphor 23 and the red phosphor 21. By setting the distances PRG, PGB and PBR in this manner, it is possible to set a black matrix width between the red phosphor 21 and the green phosphor 22, a black matrix width between the green phosphor 22 and the blue phosphor 23, and a black matrix width between the blue phosphor 23 and the red phosphor 21 to a fixed value. Here, setting of the black matrix widths to a fixed value implies that the widths of the respective black matrixes 24 agree to each other within 4% or less by taking manufacturing errors into consideration.

In FIG. 6, a pitch PP between the phosphors of same color is 0.519 mm, for example. The widths of the black matrixes 24 are equal, that is, 58 μm. Since the black matrix 24 is formed between the respective phosphors, within the pitch PP between the phosphors of the same color, the widths of the black matrix 24 occupy 174 μm. Accordingly, remaining 345 μm is allocated to the widths of the phosphors of three colors by division. Longitudinal sizes LP of the respective phosphors are 165 μm, and a longitudinal pitch of the respective phosphors is 0.519 mm. Accordingly, a lateral pitch and the longitudinal pitch when the phosphors of three colors are collected are equal to each other, that is, 0.519 mm.

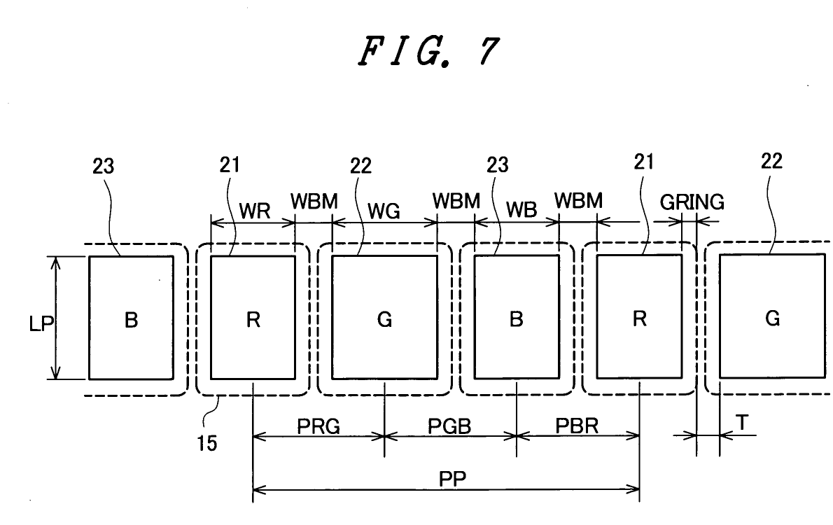

Setting of the black matrix widths between the phosphors of respective colors to a fixed value is important with respect to color purity. FIG. 7 shows a profile of the electron beams 15 when the electron beams 15 impinge on the respective phosphors. Widths of the electron beams 15 are designed to be larger than the widths of the phosphors when the electron beams 15 impinge on the phosphor screen. An amount of width by which the width of the electron beam 15 becomes larger than a width of the phosphor on one side is referred to as a guard ring and is indicated by GRING in FIG. 7. On the other hand, the tolerance which prevents the impingement of the electron beam 15 on other phosphor is referred to as other color hitting tolerance and is indicated by T in FIG. 7. In general, the guard ring GRING and the other color hitting tolerance T are designed to be equal to each other or the guard ring GRING is designed to be slightly smaller than the other color hitting tolerance T.

Even when the width WG of the green phosphor 22 is increased by 5% or more compared to the width of other phosphor, it is possible to approximate the white brightness temperature to 9300K. It is preferable to increase the width WG of the green phosphor 22 by 10% or more compared to the width of other phosphor, and it is further preferable to increase the width WG of the green phosphor 22 by 15% or more compared to the width of other phosphor.

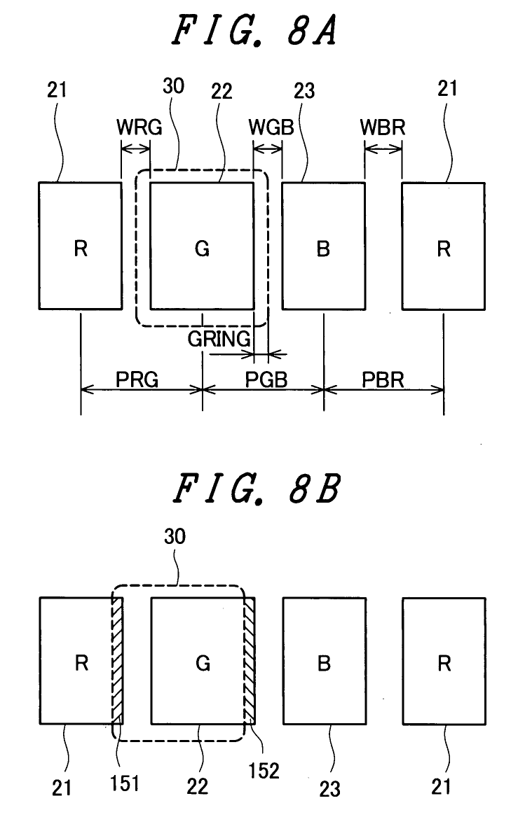

For a comparison purpose, FIG. 8A shows a state in which the distances between centers of the respective phosphors are set to a fixed value and the width of the green phosphor 22 is increased. In FIG. 8A, the distance PRG between the red phosphor 21 and the green phosphor 22, the distance PGB between the green phosphor 22 and the blue phosphor 23, and the distance PBR between the blue phosphor 23 and the red phosphor 21 are all equal to each other. A dotted line shown in FIG. 8A indicates a profile of electron beam 30. The guard ring and the other color hitting tolerance are respectively set to one half of the BM distance WRG between the red phosphor 21 and the green phosphor 22. In this case, the black matrix width WRG between the red phosphor 21 and the green phosphor 22 is set smaller than the black matrix width WBR between the blue phosphor 23 and the red phosphor 21. Such an arrangement cannot acquire the sufficient guard ring GRING or the sufficient other color hitting tolerance T. Accordingly, when the electron beams 30 are displaced due to mating displacement or the like between the anode substrate 2 and the cathode substrate 1, the other color hitting or a beam absence of the electron beams 30 is generated. FIG. 8B shows such a state. To facilitate the understanding of FIG. 8B, only the electron beams 30 corresponding to the green phosphor 22 is shown. A portion indicated by hatching 151 shows a state in which the electron beam 30 which is originally assigned to hit the green phosphor 22 hits the red phosphor 21. A portion indicated by hatching 152 shows a state in which the electron beam 30 which is assigned to hit the green phosphor 22 does not hit a portion of the green phosphor 22. On the other hand, the black matrix width WBR between the red phosphor 21 and the blue phosphor 23 is larger than the black matrix width WRG between the red phosphor 21 and the green phosphor 22 and hence, even when the electron beam 30 corresponding to the green phosphor 22 generates other color hitting or a beam absence, the electron beam which hits the red phosphor 21 does not generate other color hitting or a beam absence. This phenomenon deteriorates uniformity of the white screen (white uniformity).

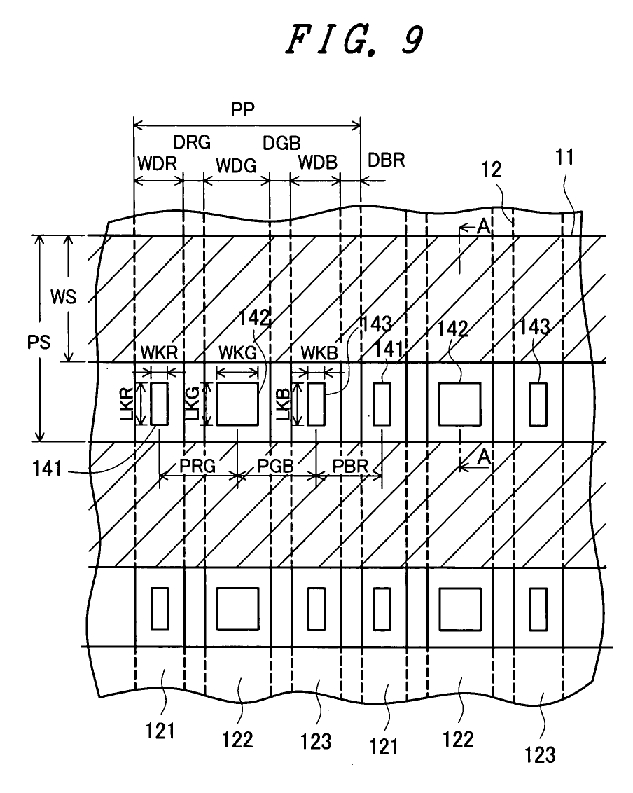

FIG. 9 shows the constitution on the cathode substrate corresponding to the arrangement of the phosphor screen in the embodiment 1 shown in FIG. 7. In FIG. 9, the data signal lines 12 extend in the longitudinal direction of the screen. Above the data signal lines 12, the scanning lines 11 extend in the horizontal direction orthogonal to the data signal lines 12 while sandwiching the insulation film 13 between the data signal lines 12 and the scanning lines 11. The electron sources 14 are formed on the data signal line 12 between the scanning lines 11. In this embodiment, the electron sources 14 are formed of an MIM electron source. Since the scanning line 11 is provided for supplying electricity to the whole electron sources, the scanning line has a particularly large width. A pitch of the scanning lines 11 is 0.519 mm, for example, and a width of the scanning line 11 is 0.3 mm. A pitch of the data signal lines 12 is 0.173 mm, for example, and a width of the data signal line 12 is 0.115 mm.

The respective electron sources 14 are formed to be positioned in the vicinity of centers of the widths WDR, WDG, WDB of the respective data signal lines 12. A size of the electron source corresponding to the red phosphor 21 (hereinafter referred to as a red electron source 141) and a size of the electron source corresponding to the blue phosphor 23 (hereinafter referred to as a blue electron source 143) are equal to each other. For example, a width WKR or a width WKB is 50 μm, and a length LKR or a length LKB is 100 μm. The width WKG of the electron source corresponding to the green phosphor 22 (hereinafter referred to as a green electron source 142) is larger than the width of other electron source. The width WKG of the green electron source 142 is 60 μm, for example. The length LKG of the green electron source 142 is equal to the length of other electron source, that is, 100 μm.

The widths of the data signal lines 12 differ from each other depending on the electron sources formed on the data signal line 12. The width WDR of the data signal line 12 on which the red electron sources 141 are formed (hereinafter referred to as a red signal line 121) and the width WDB of the data signal line 12 on which the blue electron sources 143 are formed (hereinafter referred to as a blue signal line 123) are equal to each other. The width WDG of the data signal line 12 on which the green electron sources 142 are formed (hereinafter referred to as a green signal line 122) is set larger than the widths of other data signal lines 12. The width WDG of the green signal line 122 is set larger by an amount corresponding to the increase of the width of the green electron source 142. Here, the arrangement distance (pitch) PRG between the red electron source 141 and the green electron source 142 is set larger than the arrangement distance (pitch) PBR between the blue electron source 143 and the red electron source 141. Further, the arrangement distance (pitch) PGB between the green electron source 142 and the blue electron source 143 is also set larger than the arrangement distance (pitch) PBR between the blue electron source 143 and the red electron source 141. In conformity with the size relationship among the arrangement distances (pitches) of the respective color electron sources, the size relationship of the arrangement distances (pitches) of the respective color data signal lines is set in the same manner. In this manner, the widths of the data signal lines are determined in proportion to the widths (sizes) of the electron sources and hence, the line resistances of the data signal lines can be decreased whereby a load of a data signal drive circuit which are connected with these data signal lines can be reduced thus bringing about a cost reduction effect of the display device as a whole. Further, since the respective electron sources are positioned in the vicinity of the centers of the widths of the respective color data signal lines, the process tolerance in the formation of cathode lines can be enhanced.

Further, with respect to the above-mentioned size relationship among the widths of the electron sources of the respective colors, the widths of the respective color data signal lines may be adjusted such that the width DRG of a gap region between the red signal line 121 and the green signal line 122, the width DGB of a gap region between the green signal line 122 and the blue signal line 123, and the width DBR of a gap region between the blue signal line 123 and the red signal line 121 become substantially equal to each other. When the widths of the gap regions of the respective color data signal lines become substantially equal to each other, the tolerance of the wiring process is further enhanced.

Due to the above-mentioned constitution, the center of the electron beam 15 from the electron source agrees to the center of the phosphor corresponding to the electron beam 15. Accordingly, even when the width of the green phosphor 22 is increased for setting the white color temperature to a value around the desired 9300K, the display device can maintain the brightness without damaging white uniformity.

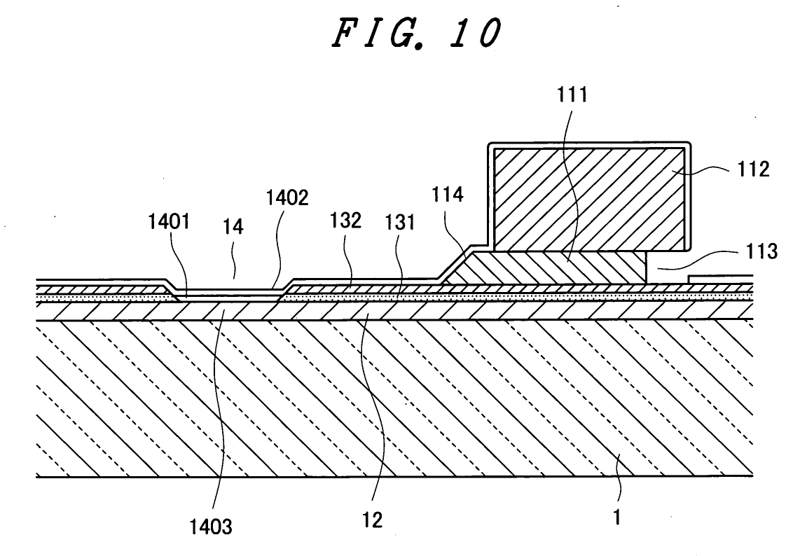

FIG. 10 is a cross-sectional view taken along a line A-A in FIG. 9, and shows the constitution of the MIM electron source. In FIG. 10, the data signal lines 12 made of Al alloy and having a thickness of approximately 600 nm extend on the cathode substrate 1 in the lateral direction. A two-layered insulation film consisting of a first insulation film 131 and a second insulation film 132 is formed on the data signal lines 12. The first insulation film 131 is formed of an Al₂O₃ film acquired by anodizing Al. The second insulation film 132 is formed of a silicon oxide film or a silicon nitride film.

On the second insulation film 132, the scanning lines 11 are formed in the direction orthogonal to the data signal lines 12 and in the normal direction of a surface of the drawing. The scanning line 11 adopts the two-layered structure. A first scanning line layer 111 is made of Cr and has a thickness of approximately 400 nm. A second scanning line layer 112 is formed on the first scanning line layer 111, and the second scanning line layer 112 is made of aluminum alloy and has a thickness of 4.5 μm. The scanning line 11 supplies an electron current on one line and hence, a large electric current flows in the scanning line 11 whereby the scanning line 11 is formed with a large width and a large thickness.

The data signal line 12 is used as a lower electrode 1403 of the electron source 14. In the electron source 14, a thin insulation film having a thickness of approximately 7 nm is formed on the data signal line 12, and this insulation film constitutes a tunnel insulation film 1401. The tunnel insulation film 1401 is an Al₂O₃ film formed by anodizing Al alloy which forms the lower electrode 1403. As an upper electrode 1402 of the electron source 14, as tacked film made of Ir, Pt, Au and having a thickness of approximately 6 nm in total is formed by sputtering. The stacked layer made of Ir, Pt, Au is formed on a whole surface of the cathode substrate by sputtering. Although the stacked film made of Ir, Pt, Au constitutes the upper electrode 1402 of the electron source, the stacked film also plays a role of making the scanning line 11 and the upper electrode 1402 of the electron source conductive with each other.

In etching the scanning line 11 formed as the two-layered film, to make the upper electrode 1402 of the electron source conductive with only one scanning line 11, an etching condition is controlled such that a tapered portion 114 for making the scanning line 11 conductive with the upper electrode 1402 is formed on one side of the two-layered film and eaves 113 for insulation are formed on another side of the two-layered film.

Due to the electron sources 14 having the above-mentioned constitution, a scanning line voltage is applied to the upper electrode 1402 of the electron source 14, a signal line voltage is applied to the lower electrode 1403 of the electron source 14, and some electrons which penetrate the tunnel insulation film 1401 due to a potential difference between the upper electrode 1402 and the lower electrode 1403 are emitted from the upper electrode 1402.

### Embodiment 2

In the embodiment 1, the widths of the black matrixes 24 between the respective phosphors are set to a fixed value while setting the width of the green phosphor 22 larger than the widths of other phosphors. Further, the positions and the sizes of the electron sources are also changed in conformity with such an arrangement. As a result, the distances between the centers of the data signal lines 12 on which the respective electron sources are arranged are also changed in conformity with the distances between the centers of the respective phosphors on the phosphor screen. Accordingly, when the data signal lines 12 are extended to the data signal line terminals 52, pitches between the terminals differ from each other.

The terminals 5 are connected to a flexible printed circuit board in general. In view of a demand for the reduction of cost, lines on the flexible printed circuit board adopt the unified constitution in many cases. Pitches between the terminals formed on the cathode substrate 1 which are connected with the flexible printed circuit board are preferably set uniform. Particularly, when the display device adopts a high definition screen, the pitch between the terminals becomes small and hence, this demand is further boosted. The embodiment 2 is provided to satisfy such a demand.

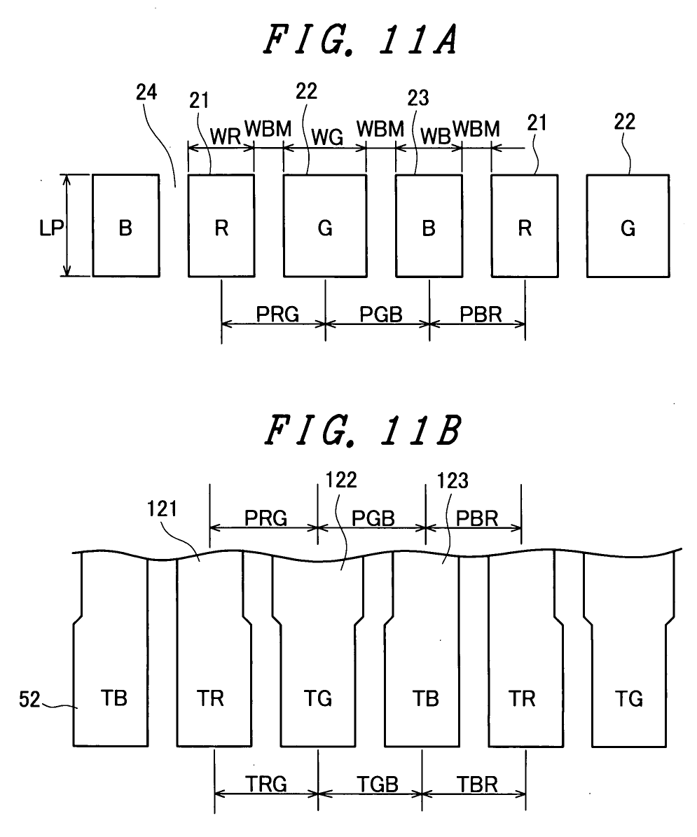

FIG. 11A and FIG. 11B show the constitution of a phosphor screen of a display device according to the embodiment 2 of the present invention. The constitution of the phosphor screen of the display device shown in FIG. 11A is equal to the constitution of the phosphor screen of the display device of the embodiment 1 shown in FIG. 6. FIG. 11B shows the constitution of data signal lines and terminal portions corresponding to the phosphor screen shown in FIG. 11A. In FIG. 11B, distances between centers of the respective data signal lines 12 consisting of red signal lines 121, green signal lines 122 and blue signal lines 123 are equal to distances between centers of red phosphors 21, green phosphors 22 and blue phosphors 23 shown in FIG. 11A. However, pitches between terminals are set to a fixed value by changing widths of the data signal lines 12 just in front of the terminal portion in the specific direction.

In FIG. 11B, the widths of the red signal line 121 and the blue signal line 123 are increased toward a green signal line side just in front of the terminal portion. That is, the widths of the red signal line 121 and the blue signal line 123 are increased asymmetrically. On the other hand, a width of the green signal line 122 is decreased symmetrically just in front of the terminal portion. Due to such a constitution, it is possible to set the distances between the centers of a terminal TR of the red signal line 121, a terminal TG of the green signal line 122 and a terminal TB of the blue signal line 123 at the terminal portion equal to each other. That is, the distances TRG, TGB, TBR shown in FIG. 11B are set equal to each other. Further, by adopting such a constitution, the reliability of connection between the terminal portion and the flexible printed circuit board can be enhanced.

Here, it is needless to say that the method shown in FIG. 11B is merely one example for setting the pitches of the terminals at the terminal portion to a fixed value and other arrangement method can be adopted.

### Embodiment 3

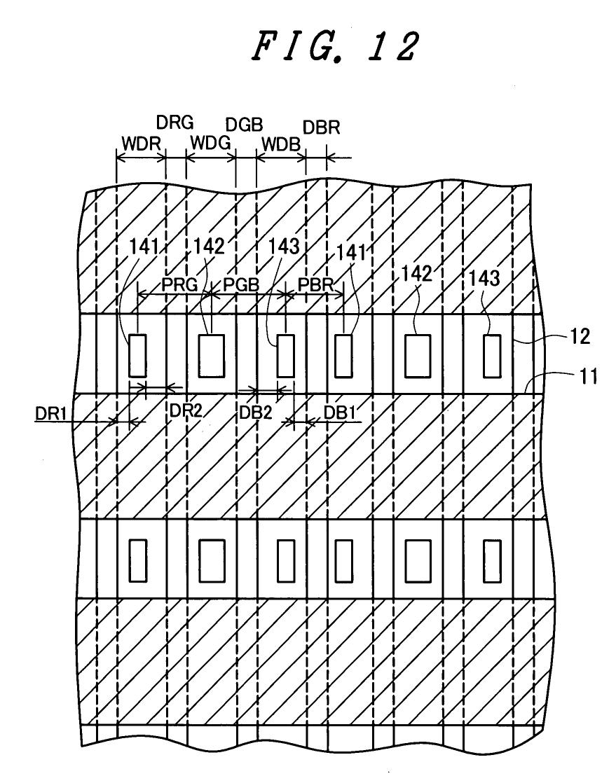

FIG. 12 shows the constitution of a cathode substrate of a display device according to an embodiment 3 of the present invention. The structure of a phosphor screen of the embodiment 3 is equal to the structure of the phosphor screen of the embodiment 1 shown in FIG. 6. In the embodiment 1, the width of the green signal line 122 is increased corresponding to the size relationship that the width of the green phosphor 22 is larger than the widths of other phosphors and, at the same time, the distances between the centers of the respective data signal lines 12 are changed. Here, when only the width of the green signal line 122 is increased, lowering of an upper voltage of the electron source is decreased only with respect to the green signal. As a result, a balance between green and other colors is destroyed thus giving rise to a possibility that the accurate color reproduction cannot be achieved. Another drawback which arises when the distances between the centers of the data signal lines 12 differ from each other is that pitches between the terminals become non-uniform when the data signal lines 12 are directly extended to the terminals. When the terminal pitches become non-uniform, in connecting the terminals with an external circuit using a flexible printed circuit board or the like, there exists a possibility that the reliability of the terminals is damaged.

The embodiment 3 is provided for overcoming the above-mentioned drawbacks. FIG. 12 is a partial plan view of a cathode substrate 1 showing the embodiment 3. In the same manner as the embodiment 1, this embodiment 3 also uses MIM electron sources as electron sources. In FIG. 12, respective widths WDR, WDG, WDB of a red signal line 121, a green signal line 122 and a blue signal line 123 are equal to each other. Further, distances between centers of the red signal line 121, the green signal line 122 and the blue signal line 123 are also equal to each other. In FIG. 12, while the center of a green electron source 142 is made to agree to the center of the green signal line 122, positions of a red electron source 141 and a blue electron source 143 are respectively offset from the centers of the red signal line 121 and the blue signal line 123.

That is, in FIG. 12, with respect to the red signal line 121, assuming a distance between an edge portion of the red electron source 141 and an edge portion of the red signal line 121 as DR2 on a green-phosphor-22 side and as DR1 on a side opposite to the green-phosphor-22 side, the relationship between the distances DR1, DR2 is set to DR2>DR1. On the other hand, with respect to the blue signal line 123, assuming a distance between an edge portion of the blue electron source 143 and an edge portion of the blue signal line 123 as DB2 on the green-phosphor-22 side and as DB1 on a side opposite to the green-phosphor-22 side, the relationship between the distances DB1, DB2 is set to DB2>DB1. However, the center of the green signal line 122 and the center of the green electron source 142 agree to each other.

By adopting such a constitution, it is possible to make the centers of the electron sources and the center of the phosphors agree to each other even when the pitches of the data signal lines 12 are set to a fixed value. Here, also in this embodiment, the width of the green electron source 142 is set larger than the width of the red electron source 141 and the blue electron source 143. Due to such a constitution, in the profile relationship between the phosphor and the electron beam 15, all colors respectively exhibit the same beam absence tolerance and the other color hitting tolerance.

As described above, according to the constitution of this embodiment, in the phosphor screen, even when the distances between the centers of the phosphors are changed by increasing the width of the green phosphor 22, sizes of the electron sources can be changed in conformity with the sizes of the phosphors and, at the same time, the pitches of the data signal lines 12 can be set to a fixed value. Due to such a constitution, there is no possibility that values of resistances of the data signal lines 12 are changed for respective colors so that the color balance is destroyed. Further, even when the data signal lines 12 directly extend to an end portion of the cathode substrate, the terminals can be formed at a fixed pitch. Accordingly, the reliability of the terminal portion can also be enhanced.

### Embodiment 4

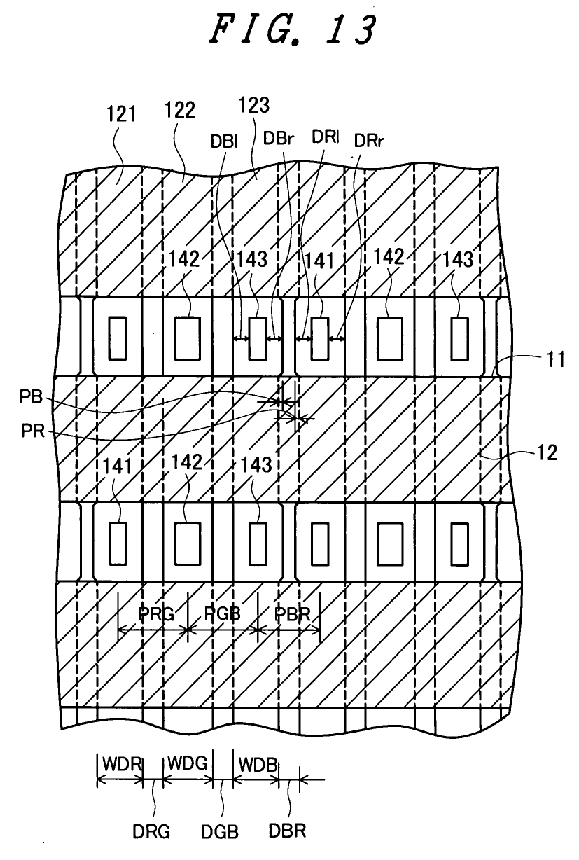

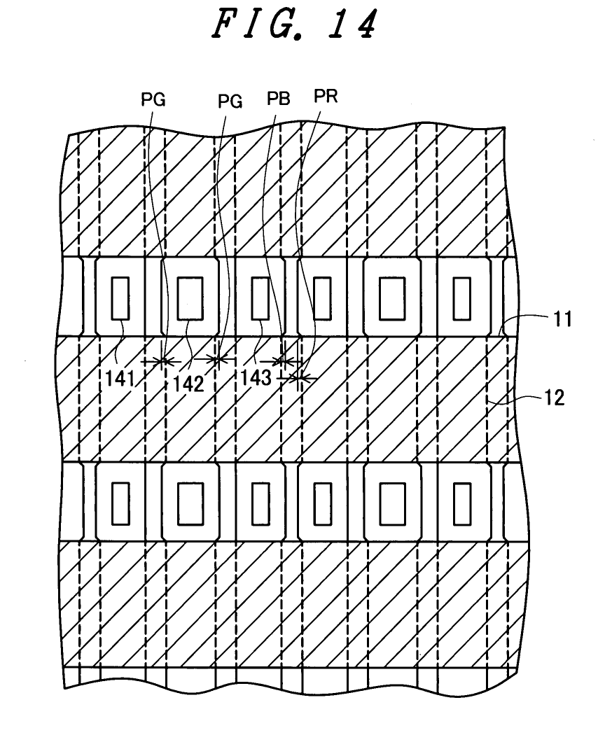

FIG. 13 shows the structure of a phosphor screen of a display device of an embodiment 4 of the present invention. This embodiment is a modification of the embodiment 3. The structure of the phosphor screen of the embodiment 4 is equal to the structure of the phosphor screen of the embodiment 1 shown in FIG. 6. MIM electron sources are used as electron sources. In FIG. 13, a distance PRG between a red electron source 141 and a green electron source 142, a distance PGB between the green electron source 142 and a blue electron source 143, and a distance PBR between the blue electron source 143 and the red electron source 141 are set equal to distances between the centers of the corresponding phosphors. Line widths of the red signal lines 121, the green signal lines 122 and the blue signal lines 123 on which the respective electron sources are mounted are equal to each other and, at the same time, the distances between the centers of the respective data signal lines 12 are equal to each other. However, in the same manner as the embodiment 3, the red electron source 141 and the blue electron source 143 are respectively offset from the center of the red signal line 121 and the center of the blue signal line 123. Further, due to this offset quantity, the center of the red electron source 141 and the center of the red phosphor 21 agree to each other, the center of the green electron source 142 and the center of the green phosphor 22 agree to each other, and the center of the blue electron source 143 and the center of the blue phosphor 23 agree to each other.

According to this embodiment, the width of the data signal line 12 is increased toward a red electron source side only by an amount PB corresponding to the offset quantity of the center of the blue electron source 143 from the center of a blue signal line 123 at a portion of the data signal line 12 where the electron source is present. Further, the width of the red signal line 121 is also increased on the blue-signal-line-123 side by an amount PR in the same manner. In this manner, by increasing the width of the portion of the data signal line 12 on which the electron sources are present on one side, distances to edge portions of the data signal lines 12 as viewed from the electron source can be set equal to each other. Since a potential of the data signal line 12 is lower than a potential of an upper electrode 1402 of the MIM electron source, there exists a possibility that the width of the data signal line 12 which is present on one side of the electron source influences the movement of the electron beam 15. Further, when the width of the data signal line 12 is large on one side of the electron source, the distribution of the potential becomes imbalanced laterally thus giving rise to a possibility that the electron beam 15 is deflected.

In this embodiment, by increasing the widths of the red signal line 121 and the blue signal line 123 on one side by the offset quantity of the electron source, it is possible to obviate a possibility that the electron beam 15 is deflected so that landing of the electron beam 15 is deteriorated. In all data signal lines 12, when the width of the electron source and the width of the data signal line 12 are increased on one side by an offset quantity, a distance between the data signal lines 12 becomes smaller thus giving rise to a drawback that the data signal lines 12 are short-circuited to each other. In this embodiment, only the width of the portion of the data signal line 12 where the electron source is present is increased on one side thus reducing a possibility that the data signal lines 12 are short-circuited to each other.

As described above, according to this embodiment, even when the width of the green phosphor 22 on the phosphor screen is increased and the pitches of the respective phosphors are changed, the widths of the data signal lines 12 can be set equal to each other, and the data signal lines 12 can be arranged at the same pitch thus making the center of the electron source and the center of the phosphor agree to each other. Further, according to this embodiment, it is also possible to obviate the danger that the electron beam 15 is deflected toward one side.

### Embodiment 5

FIG. 14 shows the constitution on the cathode substrate of a display device according to the embodiment 5 of the present invention. The structure of a phosphor screen of the embodiment 5 is substantially equal to the structure of the phosphor screen of the embodiment 1 shown in FIG. 6. MIM electron sources are used as electron sources. This embodiment is a further modification of the embodiment 4. In FIG. 14, widths of the data signal lines 12, distances between the centers of data signal lines 12, distances between the centers of the electron sources and the like are substantially equal to those of the embodiment 4. The constitution which makes this embodiment differ from the embodiment 4 lies in that a width of a portion of the green signal line 122 is increased on both sides by an amount PG at a portion of the green signal line 122 where an electron source is formed.

A potential of an upper electrode 1402 of the electron source is higher than a potential of the data signal line 12 which constitutes a lower electrode 1403. Accordingly, an electron beam 15 emitted from the electron source receives a focusing action by the data signal line 12. When distances between edge portions of the respective electron sources and edge portions of the data signal line 12 differ from each other, the focusing actions which the electron beams 15 receive differ from each other and hence, there may be a case that conditions of landing of electron beams 15 on the phosphors differ from each other for respective colors. This phenomenon deteriorates the white uniformity. In the embodiment 4 or the like, the distance between the edge portion of the green electron source 142 and the edge portion of the green signal line 122 is set smaller than the distance between the edge portion of the red electron source 141 and the edge portion of the red signal line 121. The same goes for the corresponding relationship with respect to the blue signal line 123.

In this embodiment, as shown in FIG. 14, a width of a portion of the green signal line 122 on which the green electron source 142 is present is increased on both sides by an amount PG. Due to such a constitution, a distance from the edge portion of the green electron source 142 to the edge portion of the green signal line 122 can be set in the same manner as the red electron source or the like.

Due to such a constitution, the red electron source 141, the green electron source 142 and the blue electron source 143 can have the same spreading of the electron beam 15 thus enhancing the white uniformity.

### Embodiment 6

In the embodiment 1 to the embodiment 5, the width of the green phosphor 22 is increased to set the white color temperature to approximately 9300K. However, the light emitting efficiencies of the phosphors of respective three colors differ from each other and hence, in an attempt to adjust the color temperature accurately, the mere increase of the area of the green phosphor 22 is not sufficient to accurately adjust the color temperature. In an attempt to realize the white color temperature of 9300K while setting the areas of the phosphors equal to each other, the brightness of the green phosphor 22 becomes most insufficient in quantity and the brightness of the blue phosphor 23 becomes next-most insufficient in quantity. Accordingly, to realize the white color temperature of 9300K accurately, it is also desirable to set the width of the blue phosphor 23 larger than the width of the red phosphor 21.

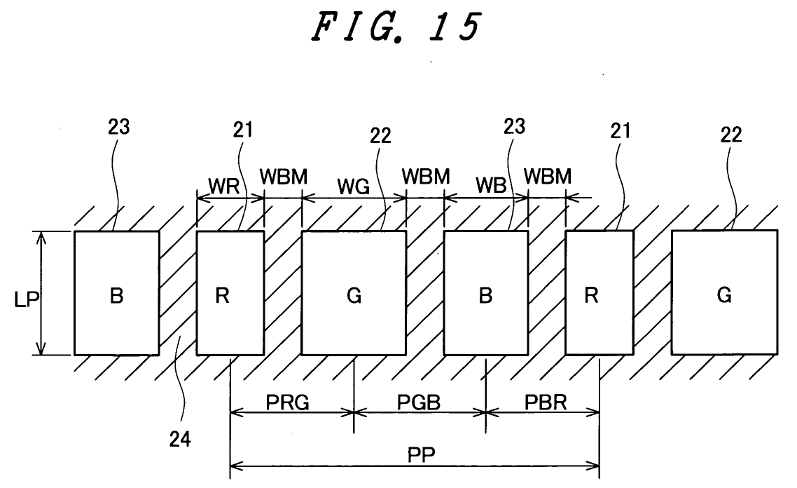

FIG. 15 is a partially enlarged view showing the constitution of the phosphor screen of the display device according to embodiment 6 of the present invention. In FIG. 15, with respect to widths of phosphors, a width WG of the green phosphor 22 assumes a largest value, a width WB of the blue phosphor 23 assumes a second-largest value, and a width WR of the red phosphor 21 assumes a smallest value. A ratio of widths of respective phosphors is set to WG:WB:WR=1:0.90:0.85, for example. According to another evaluation, the display device of this embodiment can obtain the sufficient white uniformity effect even when the ratio of widths of respective phosphors is set to WG:WB:WR=1:0.95:0.90.

Corresponding to amounts of differences among widths of the phosphors, the distances between the centers of the respective phosphors are also made different from each other. This provision is adopted for setting the black matrix widths between the respective phosphors to a fixed value thus ensuring color purity. In FIG. 15, to compare the distance PRG between the centers of the red phosphor 21 and the green phosphor 22, the distance PGB between the centers of the green phosphor 22 and the blue phosphor 23, and the distance PBR between the centers of the blue phosphor 23 and the red phosphor 21 to each other, the relationship of PGB>PRG>PBR is set. The pitch PP of the phosphors of the same color is set to the equal pitch PP from the embodiment 1 to the embodiment 5. That is, a pitch of phosphors of the same color is set to 0.519 mm or a longitudinal length LP of the phosphors of the same color is set to 0.165 mm, for example. Here, the pitch of the phosphors in the longitudinal direction is set to 0.519 mm, and both of pitches of the phosphors in the longitudinal direction as well as in the lateral direction are set to 0.519 mm when the phosphors of three colors are formed as a set.

Sizes of the electron sources corresponding to the phosphors of respective colors may preferably be changed in conformity with the sizes of the phosphors of respective colors. With respect to the sizes and the arrangement of the electron sources, the constitutions described in the embodiment 1 to the embodiment 5 are also applicable to this embodiment. That is, as a first mode of the cathode substrate side of this embodiment, the widths of the electron sources are changed corresponding to the widths of the respective phosphors and, at the same time, the widths of the respective data signal lines 12 are also changed corresponding to the widths of the corresponding phosphors. The distance between the centers of the respective electron sources and the distance between the centers of the respective data signal lines 12 are equal to the distance between the centers of the respective phosphors. In this mode, the green signal line 122 assumes the largest width, and the width of the blue signal line 123 and the width of the red signal line 121 are decreased in this order. Further, a ratio PGB/PRG of the arrangement distance (pitch) PRG between the red signal line and the green signal line and the arrangement distance (pitch) PGB between the green signal line and the blue signal line is set to a value which falls within a range of 1.1±0.1 and a ratio PBR/PRG of the arrangement distance (pitch) PRG between the red signal line and the green signal line and the arrangement distance (pitch) PBR between the blue signal line and the red signal line is set to a value which falls within a range of 0.9±0.1. The display device of this embodiment can also obtain the sufficient white uniformity effect.

A second mode of this embodiment corresponds to the arrangement of the cathode substrate of the embodiment 2. The widths of the respective electron sources, the widths of the respective data signal lines 12 and the distances between the centers of the respective data signal lines 12 of this mode are substantially equal to the corresponding sizes of the mode 1. However, by asymmetrically changing the width of the data signal line 12 just in front of the terminal portion of the data signal line 12, the pitches of the data signal lines 12 of respective colors are set equal to each other at the terminal portion.

A mode 3 of this embodiment corresponds to the constitution of the cathode substrate 1 of the embodiment 3 of the present invention. That is, the widths of the electron sources are changed in accordance with the widths of the phosphors of the respective colors. Further, the centers of the electron sources of respective colors are made to agree to the centers of the corresponding phosphors. On the other hand, by setting the centers of the electron sources offset from the centers of the data signal lines 12, it is possible to set the pitch of the data signal lines 12 and the width of the data signal lines 12 equal to each other. This offset quantity is different from the offset quantity of the embodiment 3. While only the green phosphor 22 has the large width in the embodiment 3, all of phosphors of three colors differ from each other in width in this embodiment. Due to such a constitution, even when the color temperature is adjusted by changing the widths of the phosphors on the phosphor screen, an imbalance of signals among the respective colors can be suppressed.

A fourth mode of this embodiment corresponds to the constitution of the cathode substrate 1 of the embodiment 4 of the present invention. The fourth mode of this embodiment is, in addition to the constitution of the third mode of this embodiment, characterized in that the width of the portion of the data signal line 12 on which the electron source is present is increased asymmetrically by an amount that the electron source is offset from the center of the data signal line 12. Due to such a constitution, in addition to the advantageous effects of the third mode of this embodiment, it is possible to prevent a possibility that the electron beam 15 is deflected attributed to offsetting of positions of the electron beam 15 from the data signal line 12.

A fifth mode of this embodiment corresponds to the constitution of the cathode substrate 1 of the embodiment 5 of the present invention. The fifth mode of this embodiment is, in addition to the constitution of the fourth mode of this embodiment, characterized in that the width of the green signal line 122 on which the largest green electron source 142 is present is increased at a portion of the green signal line 122 where the electron source is present. Due to such a constitution, an amount that the electron beam 15 from the green electron source 142 is influenced by an electric field generated by the data signal line 12 can be set substantially equal to an amount influenced by the electron beam 15 of other color.

Here, in the embodiment, not only the width of the green electron source 142 but also the width of the blue electron source 143 is increased compared to the width of the red electron source 141. Accordingly, by also increasing the width of a portion of the blue signal line 123 where the electron source is present, electric fields from the signal lines to the electron beams 15 corresponding to three colors can be made more uniform. In this case, the widths of the red signal line 121, the green signal line 122 and the blue signal line 123 become substantially equal to each other at portions thereof where the respective electron sources are present.

In the above-mentioned embodiment 1, in conformity with setting of the distances between the center positions of the phosphors of respective colors on the anode substrate 2 non-uniform, the distances between the center positions of the electron sources formed on the cathode substrate 1 are also made non-uniform. However, when an amount of width by which the width of the green phosphor 22 is set larger than the width of other phosphor is small, an amount of distance which makes the distances between the centers of the respective phosphors non-uniform becomes small. In such a case, there may arise no problem in a practical use even when the center positions of the electron sources are not made to agree to the positions of the centers of the respective phosphors by intentionally setting the distances between the centers of the electron sources non-uniform.

In the above-mentioned embodiments, the explanation is made by reference to the case in which the MIM electron sources are used as the electron sources. However, it is needless to say that the technical contents described in the above-mentioned embodiments are applicable to an FED which uses other electron sources such as electron sources of SED method, electrons sources of Spindt method, electron sources which make use of carbon nanotubes, for example.

What is claimed is:

1. A display device including a cathode substrate on which electron sources are mounted in a matrix array, and an anode substrate which faces the cathode substrate in an opposed manner, allows an anode voltage to be applied thereto, and forms phosphors at portions thereof corresponding to the electron sources, the display device holding a vacuum in the inside thereof, wherein
a black matrix is formed on the anode substrate, red phosphors, green phosphors and blue phosphors are arranged in parallel in opening portions formed in the black matrix, a width of the green phosphor is set larger than a width of the red phosphor or a width of the blue phosphor, a distance between the center of the red phosphor and the center of the green phosphor is set larger than a distance between the center of the red phosphor and the center of the blue phosphor, and a black matrix width between the red phosphor and the green phosphor, a black matrix width between the green phosphor and the blue phosphor, and a black matrix width between the blue phosphor and the red phosphor are set approximately equal to each other.

2. A display device according to claim 1, wherein a range of equality among the black matrix width between the red phosphor and the green phosphor, the black matrix width between the green phosphor and the blue phosphor, and the black matrix width between the blue phosphor and the red phosphor is within 4%.

3. A display device according to claim 1, wherein the width of the red phosphor is equal to the width of the blue phosphor.

4. A display device according to claim 1, wherein the distance between the center of the green phosphor and the center of the blue phosphor is larger than the distance between the center of the blue phosphor and the center of the red phosphor.

5. A display device according to claim 1, wherein the width of the green phosphor is set larger than the width of either one of the red phosphor and the blue phosphor by 5% or more.

6. A display device according to claim 1, wherein the width of the green phosphor is set larger than the width of either one of the red phosphor and the blue phosphor by 10% or more.

7. A display device according to claim 1, wherein the width of the green phosphor is set larger than the width of either one of the red phosphor and the blue phosphor by 15% or more.

8. A display device including a cathode substrate on which electron sources are mounted in a matrix array, and an anode substrate which faces the cathode substrate in an opposed manner, allows an anode voltage to be applied thereto, and forms phosphors at portions thereof corresponding to the electron sources, the display device holding a vacuum in the inside thereof, wherein
a black matrix is formed on the anode substrate, red phosphors, green phosphors and blue phosphors are arranged in parallel in opening portions formed in the black matrix, a width of the green phosphor is set larger than a width of the red phosphor or a width of the blue phosphor, a distance between the center of the red phosphor and the center of the green phosphor is set larger than a distance between the center of the red phosphor and the center of the blue phosphor, and
red electron sources which allow electrons to impinge on the red phosphors, green electron sources which allow electrons to impinge on the green phosphors, and blue electron sources which allow electrons to impinge on the blue phosphors are formed on the cathode substrate, and a distance between the center of the red electron source and the center of the green electron source is set larger than a distance between the center of the red electron source and the center of the blue electron source.

9. A display device according to claim 8, wherein a distance between the center of the green electron source and the center of the blue electron source is set larger than a distance between the center of the blue electron source and the center of the red electron source.

10. A display device according to claim 8, wherein the difference between a distance between the center of the red electron source and the center of the green electron source and a distance between the center of the blue electron source and the center of the red electron source is made in the direction which makes the center of the red electron source and the center of the red phosphor agree to each other and in the direction which makes the center of the green electron source and the center of the green phosphor agree to each other.

11. A display device according to claim 9, wherein a distance between the center of the green electron source and the center of the blue electron source is set larger than a distance between the center of the blue electron source and the center of the red electron source, and the difference between a distance between the center of the green electron source and the center of the blue electron source and a distance between the center of the blue electron source and the center of the red electron source is made in the direction which makes the center of the green electron source and the center of the green phosphor agree to each other and in the direction which makes the center of the blue electron source and the center of the blue phosphor agree to each other.

12. A display device according to claim 8, wherein a signal line which supplies a signal to the green electron source has a width larger than a width of a signal line which supplies a signal to another electron source.

13. A display device according to claim 8, wherein a signal line which supplies a signal to the red electron source, a signal line which supplies a signal to the green electron source, and a signal line which supplies a signal to the blue electron source are arranged at a same pitch.

14. A display device according to claim 8, wherein a width of a signal line which supplies a signal to the red electron source, a width of a signal line which supplies a signal to the green electron source and a width of a signal line which supplies a signal to the blue electron source are set equal to each other.

15. A display device according to claim 8, wherein the red electron source is formed on a red signal line which supplies a signal to the red electron source, the green electron source is formed on a green signal line which supplies a signal to the green electron source, and the blue electron source is formed on a blue signal line which supplies a signal to the blue electron source, and the center of the red electron source is offset from the center of the red signal line or the center of the blue electron source is offset from the center of the blue signal line.

16. A display device according to claim 8, wherein the red electron source is formed on a red signal line which supplies a signal to the red electron source, the green electron source is formed on a green signal line which supplies a signal to the green electron source, and the blue electron source is formed on a blue signal line which supplies a signal to the blue electron source, and a width of the red signal line in the vicinity of the red electron source is set larger than the width of the red signal line in other portions or a width of the blue signal line in the vicinity of the blue electron source is set larger than the width of the blue signal line in other portions.

17. A display device including a cathode substrate on which electron sources are mounted in a matrix array, and an anode substrate which faces the cathode substrate in an opposed manner, allows an anode voltage to be applied thereto, and forms phosphors at portions thereof corresponding to the electron sources, the display device holding a vacuum in the inside thereof, wherein
a black matrix is formed on the anode substrate, red phosphors, green phosphors and blue phosphors are arranged in parallel in opening portions formed in the black matrix, a width of the green phosphor is set larger than a width of the blue phosphor, and a width of the blue phosphor is set larger than a width of the red phosphor,
a distance between the center of the red phosphor and the center of the green phosphor is set larger than a distance between the center of the red phosphor and the center of the blue phosphor, and a black matrix width between the red phosphor and the green phosphor, a black matrix width between the green phosphor and the blue phosphor, and a black matrix width between the blue phosphor and the red phosphor are set approximately equal to each other.

18. A display device according to claim 17, wherein a range of equality among the black matrix width between the red phosphor and the green phosphor, the black matrix width between the green phosphor and the blue phosphor, and the black matrix width between the blue phosphor and the red phosphor is within 4%.

19. A display device according to claim 17, wherein the width of the red phosphor is 0.9 times or less as large as the width of the green phosphor.

20. A display device according to claim 17, wherein the width of the red phosphor is 0.85 times or less as large as the width of the green phosphor.
